(19) United States
(12) Patent Application Publication
(10) Pub. No.: US 2013/0169554 A1
(43) Pub. Date: Jul. 4, 2013

(54) ELECTRONIC DEVICE WITH TOUCH PANEL UNLOCKING AND METHOD FOR UNLOCKING ELECTRONIC DEVICE

(71) Applicant: HSING-CHUN HSIEH, Shindian (TW)

(72) Inventor: HSING-CHUN HSIEH, Shindian (TW)

(73) Assignee: FIH (Hong Kong) Limited, Kowloon (HK)

(21) Appl. No.: 13/567,077

(22) Filed: Aug. 5, 2012

(30) Foreign Application Priority Data
Dec. 30, 2011 (TW) 100149929

(51) Int. Cl. G06F 3/041

(52) U.S. Cl. 345/173

(57) ABSTRACT

In a method for unlocking an electronic device, touch signals are received on one or both of an obverse touch panel and a reverse touch panel of the electronic device. Corresponding touch numerals are determined according to the received touch signals, and the electronic device is unlocked when the touch numerals are equal to preset unlocking numerals.

### BACKGROUND

1. Technical Field

Embodiments of the present disclosure relate to electronic device unlocking technology, and particularly to an electronic device with dual touch panels and a method for unlocking the electronic device using the dual touch panels. 2. Description of Related Art

Some electronic devices (e.g., mobile phones) may be unlocked using a slide operation on a touch panel of the electronic device. However, certain kinds of electronic devices have two touch panels (e.g., dual touch panels), and the slide operation only utilizes a single touch panel to unlock the electronic device. Therefore, a new and more secure method for unlocking an electronic device using the dual touch panels is desired.

### BRIEF DESCRIPTION OF THE DRAWINGS

FIG. 1 is a schematic diagram of one embodiment of an electronic device including an unlocking system.

FIG. 2 is a schematic diagram of function modules of the unlocking system included in the electronic device.

FIG. 3 is a flowchart of one embodiment of a method for unlocking the electronic device.

FIG. 4A-4F are schematic diagrams showing successive steps in one example of setting unlocking numbers, according to the method of FIG. 3.

FIG. 5A-5E are schematic diagrams showing successive steps in one example of receiving touch numbers for unlocking the electronic device, according to the method of FIG. 3.

### DETAILED DESCRIPTION

All of the processes described below may be embodied in, and fully automated via, functional code modules executed by one or more general purpose electronic devices or processors. The functional code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

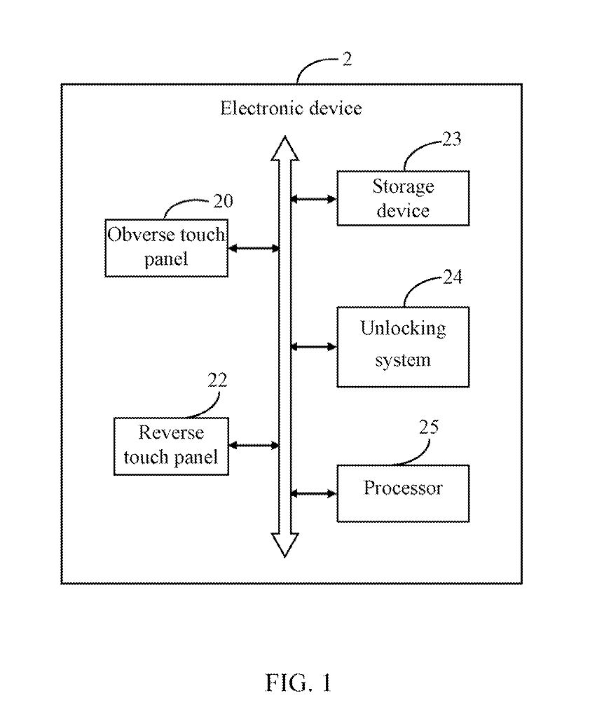

FIG. 1 is a block diagram of one embodiment of an electronic device 2 including an unlocking system 24. The electronic device 2 further includes an obverse touch panel 20, a reverse touch panel 22, a storage device 23, and at least one processor 25. The electronic device 2 may be a smart phone or a personal digital assistant (PDA). It should be understood that FIG. 1 illustrates only one example of the electronic device 2. The electronic device 2 may include more or fewer components than illustrated, or have a different configuration of the various components in other embodiments.

The obverse touch panel 20 and the reverse touch panel 22 may be resistive touch panels or capacitive touch panels. The storage device 23 may be a non-volatile computer storage chip that can be electrically erased and reprogrammed, such as a flash memory card.

The unlocking system 24 is used to provide an unlocking procedure using the obverse touch panel 20 and the reverse touch panel 22. In one embodiment, the unlocking system 24 may include computerized instructions in the form of one or more programs that are executed by the at least one processor 25 and stored in the storage device 23 (or memory). A detailed description of the unlocking system 24 will be given in the following paragraphs.

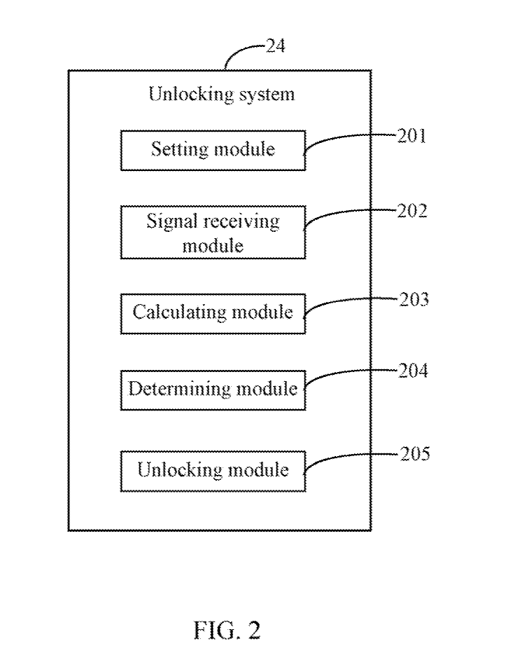

FIG. 2 is a block diagram of function modules of the unlocking system 24 included in the electronic device 2. In one embodiment, the unlocking system 24 may include one or more modules, for example, a setting module 201, a signal receiving module 202, a calculating module 203, a determining module 204, and an unlocking module 205. In general, the word “module,” as used herein, refers to logic embodied in hardware or firmware, or to a collection of software instructions, written in a programming language, such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable mediums include compact disc (CDs), digital versatile discs (DVDs), Blu-Ray disks, Flash memory, and hard disk drives.

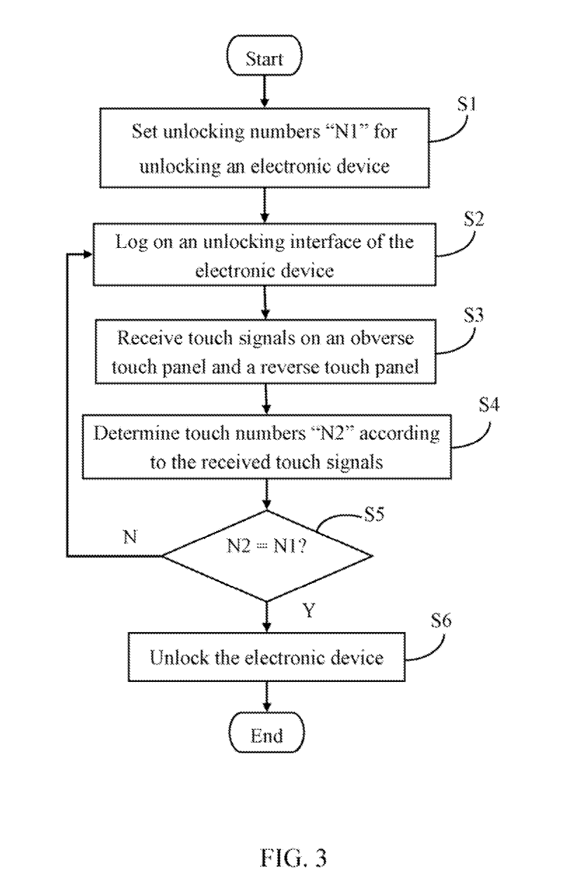

FIG. 3 is a flowchart of one embodiment of a method for unlocking the electronic device 2. Depending on the embodiment, additional steps may be added, others removed, and the ordering of the steps may be changed.

In step S1, the setting module 201 sets a series of unlocking numbers (numerals) “N1” for the unlocking operation on the obverse touch panel 20 and the reverse touch panel 22, and stores the unlocking numbers “N1” and a quantity “n” of digits present in the unlocking numbers “N1” in the storage device 23. For example, if N1={1, 2, 2, 1}, then n is 4. In one embodiment, the unlocking numbers “N1” use a first preset value (e.g., “1”) to record a touch signal on the obverse touch panel 20, and use a second preset value (e.g., “2”) to record a touch signal on the reverse touch panel 22. Thus, the unlocking numbers “N1” function as a set password for unlocking the electronic device 2. A detailed description of setting the unlocking numbers “N1” is as follows.

First, a user of the electronic device 2 opens a setting interface of the electronic device 2. Second, the user touches the obverse touch panel 20 and/or the reverse touch panel 22 of the electronic device 2 a desired total number of times (e.g., four times), one touch after the other. For each touch, the user touches either the obverse touch panel 20 or the reverse touch panel 22, as selected. In the following description, unless the context indicates otherwise, it is assumed that the user touches both the obverse touch panel 20 and the reverse touch panel 22 when performing the desired total number of touches.

Third, the setting module 201 receives the touch signals in response to the touch operations of the user, and records the touch signals as the unlocking numbers “N1” (i.e., the particular combination of the first and second preset values). A value of the quantity “n” is incrementally increased by “1” after each touch operation (n′=n+1), wherein an initial value of “n” is zero. For example, if in a first touch operation on the obverse touch panel 20 N1={1}, then n=1. If in a following second touch operation on the reverse touch panel 22 N1={1, 2}, then n=2.

Fourth, the setting module 201 stores the unlocking numbers “N1” and the quantity “n” of the unlocking numbers “N1” in the storage device 23 when the above setting operations are finished.

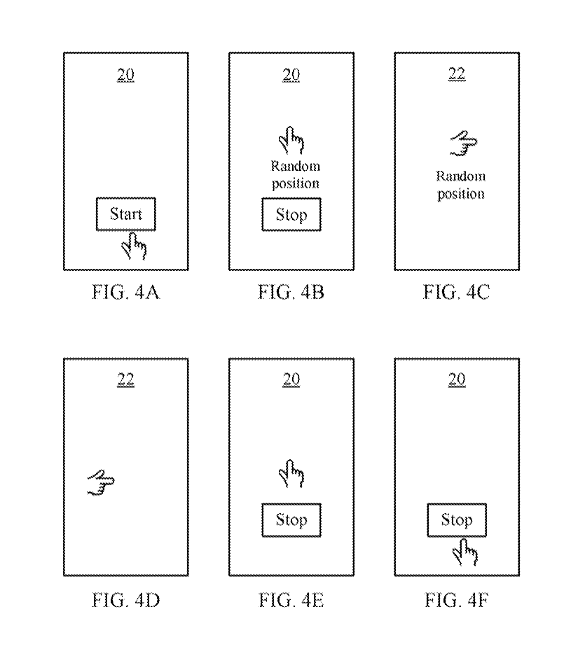

An example of setting the unlocking numbers “N1” is as follows. First, as shown in FIG. 4A, the user opens the setting interface of the electronic device 2, and selects the “start button” to start the setting process.

Second, as shown in FIG. 4B, the user touches a random position on the obverse touch panel 20, and so the setting module 201 records N1={1} and n=1.

Third, as shown in FIG. 4C, the user touches a random position on the reverse touch panel 22, and so the setting module 201 records N1={1, 2} and n=2.

Fourth, as shown in FIG. 4D, the user touches a random position on the reverse touch panel 22, and so the setting module 201 records N1={1, 2, 2} and n=3.

Fifth, as shown in FIG. 4E, the user touches a random position on the obverse touch panel 20, and so the setting module 201 records N1={1, 2, 2, 1} and n=4. That is, an unlocking mode of the electronic device 2 is to touch (or tap) as follows: obverse, reverse, reverse, obverse.

Sixth, as shown in FIG. 4F, when the user selects the “stop button,” the setting module 201 stores the unlocking numbers “N1={1, 2, 2, 1}” and the quantity “n=4” in the storage device 23.

It should be noted that in other embodiments, the unlocking numbers “N1” may be fixed and unchangeable. That is, step S1 can be omitted in this situation.

In step S2, the user opens an unlocking interface of the electronic device 2, and performs touch operations on the obverse touch panel 20 and the reverse touch panel 22.

In step S3, the signal receiving module 202 receives touch signals on the obverse touch panel 20 and on the reverse touch panel 22.

In step S4, the calculating module 203 determines a series of touch numbers (numerals) “N2” on the obverse touch panel 20 and the reverse touch panel 22 according to the received touch signals. In one embodiment, the touch numbers “N2” use the first preset value (e.g., “1”) to record a touch signal on the obverse touch panel 20, and use the second preset value (e.g., “2”) to record a touch signal on the reverse touch panel 22. For example, if a first touch operation is performed on the obverse touch panel 20, N2={1}. If a following second touch operation is performed on the reverse touch panel 22, N2={1, 2}. Thus, the touch numbers “N2” function as an input password for unlocking the electronic device 2.

In step S5, the determining module 204 determines whether the touch numbers “N2” are equal to (i.e., the same as) the unlocking numbers “N1” (i.e., whether N2=N1). If the touch numbers “N2” are equal to the unlocking numbers “N1”, the procedure goes to step S6. If the touch numbers “N2” are not equal to the unlocking numbers “N1”, the procedure returns to step S2.

In one embodiment, a variable parameter “m” is used to record a quantity of digits present in the touch numbers “N2”. For example, if N2={1, 2, 2, 1}, then m=4. A value of the quantity “m” is incrementally increased by “1” after each touch operation (m′=m+1), wherein an initial value of “m” is zero. In the present embodiment, the determining module 204 records the quantity of digits “m” present in the touch numbers “N2”. For example, if a first touch operation is performed on the obverse touch panel 20, N2={1} and m=1. If a following second touch operation is performed on the reverse touch panel 22, N2={1, 2} and m=2. The determining module 204 determines whether the touch numbers “N2” are equal to the unlocking numbers “N1”, which includes determining that “m” is equal to “n”. That is, step S5 is executed when the user finishes all of the touch operations.

In other embodiments, the determining module 204 may determine on a continuing step-by-step basis whether the touch numbers “N2” are equal to the unlocking numbers “N1” when each touch signal is received on the obverse touch panel 20 or the reverse touch panel 22, so that, when applicable, a “No” determination can be made quicker and therefore more efficiently. For example, N1={1, 2, 2, 1}, and the unlocking numbers are stored in an array “A[]”, that is, A[0]=1, A[1]=2, A[2]=2, and A[3]=1. The determining module 204 determines whether a value of a first touch signal is equal to A[0]. If the determination is “Yes,” the determining module 204 goes on to determine whether a value of a second touch signal is equal to A[1]. If the determination is “Yes,” the determining module 204 goes on to determine whether a value of a third touch signal is equal to A[2]. If the determination is “Yes,” the determining module 204 goes on to determine whether a value of a fourth touch signal is equal to A[3]. If any of the determinations is “No,” the determining module 204 simply stores the “No” determination, and uses the “No” determination when the user has finished all of the touch operations.

In step S6, the unlocking module 205 unlocks the electronic device 2. An example of unlocking the electronic device 2 using the preset unlocking numbers “N1” is as follows.

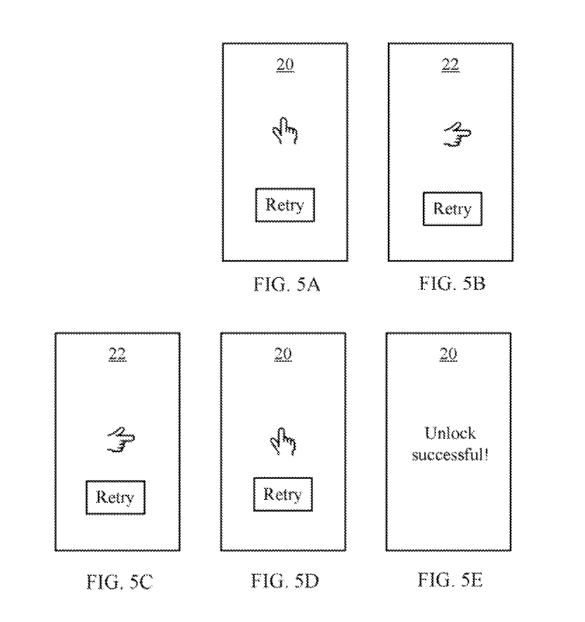

First, as shown in FIG. 5A, the user touches a random position on the obverse touch panel 20, whereby the calculating module 203 determines N2={1} and m=1. If the user believes that he/she has input a wrong unlocking serial number, a “Retry” button on the unlocking interface may be pressed to restart the unlocking operation. In the illustrated embodiment, the “Retry” button is displayed and available for use on both the obverse touch panel 20 and the reverse touch panel 22.

Second, as shown in FIG. 5B, the user touches a random position on the reverse touch panel 22, whereby the calculating module 203 determines N2={1, 2} and m=2.

Third, as shown in FIG. 5C, the user touches a random position on the reverse touch panel 22, whereby the calculating module 203 determines N2={1, 2, 2} and m=3.

Fourth, as shown in FIG. 5D, the user touches a random position on the obverse touch panel 20, whereby the calculating module 203 determines N2={1, 2, 2, 1} and m=4.

Fifth, as shown in FIG. 5E, because m equals n, and N2 equals N1, the unlocking module 205 unlocks the electronic device 2.

In other embodiments, the unlocking numbers “N1” can instead be unlocking alphabetical characters “N1”. In such case, the first preset value can be, e.g., “A”; and the second preset value can be, e.g., “B”. In still other embodiments, the unlocking numbers “N1” can instead be unlocking alphanumeric characters “N1”.

In still other embodiments, the above-described unlocking method can be used in the electronic device 2 when the electronic device 2 has only a single touch panel. For example, the single touch panel may be separated into two areas, such as a top area and a bottom area. Then, the unlocking system 24 may unlock the electronic device 2 by detecting touch signals on the top area and on the bottom area of the single touch panel. That is, the top area of the single touch panel is the functional equivalent of the above-described obverse touch panel 20, and the bottom area of the single touch panel is the functional equivalent of the above-described reverse touch panel 22.

It should be emphasized that the above-described embodiments are merely possible examples of implementations, set forth for a clear understanding of the principles of the disclosure. Many variations and modifications may be made to the above-described embodiments without departing substantially from the spirit and principles of the disclosure. All such modifications and variations are intended to be included herein within the scope of this disclosure and may be protected by the following claims.

What is claimed is:

1. A computer-implemented method for unlocking an electronic device, the electronic device comprising a processor, the method comprising:
receiving a plurality of touch signals on one or both of an obverse touch panel and a reverse touch panel of the electronic device;
determining a plurality of corresponding touch numerals according to the received touch signals; and
unlocking the electronic device on condition that the touch numerals are equal to a plurality of preset unlocking numerals.

2. The method according to claim 1, further comprising:
presetting a series of unlocking numerals corresponding to unlocking operations performed on one or both of the obverse touch panel and the reverse touch panel, and storing the unlocking numerals and a quantity of digits present in the unlocking numerals in a storage device of the electronic device.

3. The method according to claim 2, wherein presetting the series of unlocking numerals comprises recording any touch signal on the obverse touch panel using a first preset value, and recording any touch signal on the reverse touch panel using a second preset value.

4. The method according to claim 1, wherein determining a plurality of corresponding touch numerals comprises recording any touch signal on the obverse touch panel using a first preset value, and recording any touch signal on the reverse touch panel using a second preset value.

5. The method according to claim 4, further comprising:
determining whether the touch numerals are equal to the preset unlocking numerals.

6. The method according to claim 5, further comprising:
recording a quantity of digits present in the touch numerals, by adding one to a running total of the quantity of digits present each time a touch signal is received on the obverse touch panel and each time a touch signal is received on the reverse touch panel, wherein determining whether the touch numerals are equal to the preset unlocking numerals comprises determining whether the quantity of digits present in the touch numerals is equal to a quantity of digits present in the preset unlocking numerals.

7. The method according to claim 4, wherein the first preset value is one, and the second preset value is two.

8. An electronic device, comprising:
an obverse touch panel;
a reverse touch panel;
a storage device;
at least one processor; and
one or more modules that are stored in the storage device and are executed by the at least one processor, the one or more modules comprising:
a signal receiving module that receives a plurality of touch signals on one or both of the obverse touch panel and the reverse touch panel;
a calculating module that determines a plurality of corresponding touch numerals according to the received touch signals; and
an unlocking module that unlocks the electronic device on condition that the touch numerals are equal to a plurality of preset unlocking numerals.

9. The electronic device according to claim 8, wherein the one or more modules further comprise:
a setting module that presets a series of unlocking numerals corresponding to unlocking operations performed on one or both of the obverse touch panel and the reverse touch panel, and stores the unlocking numerals and a quantity of digits present in the unlocking numerals in the storage device.

10. The electronic device according to claim 9, wherein the setting module presets the series of unlocking numerals by recording any touch signal on the obverse touch panel using a first preset value, and recording any touch signal on the reverse touch panel using a second preset value.

11. The electronic device according to claim 8, wherein the calculating module determines the plurality of corresponding touch numerals by recording any touch signal on the obverse touch panel using a first preset value, and recording any touch signal on the reverse touch panel using a second preset value.

12. The electronic device according to claim 11, wherein the one or more modules further comprise:
a determining module that records a quantity of digits present in the touch numerals by adding one to a running total of the quantity of digits present each time a touch signal is received on the obverse touch panel and each time a touch signal is received on the reverse touch panel, and that determines whether the touch numerals are equal to the preset unlocking numerals, wherein the determination whether the touch numerals are equal to the preset unlocking numerals comprises a determination whether the quantity of digits present in the touch numerals is equal to a quantity of digits present in the preset unlocking numerals.

13. The electronic device according to claim 11, wherein the first preset value is one, and the second preset value is two.

14. A non-transitory storage medium having stored thereon instructions that, when executed by a processor of an electronic device, causes the electronic device to perform a method for unlocking the electronic device, the method comprising:
receiving a plurality of touch signals on one or both of an obverse touch panel and a reverse touch panel of the electronic device;
determining a plurality of corresponding touch numerals according to the received touch signals; and
unlocking the electronic device on condition that the touch numerals are equal to a plurality of preset unlocking numerals.

15. The non-transitory storage medium according to claim 14, wherein the method further comprises:
presetting a series of unlocking numerals corresponding to unlocking operations performed on one or both of the obverse touch panel and the reverse touch panel, and storing the unlocking numerals and a quantity of digits present in the unlocking numerals in a storage device of the electronic device.

16. The non-transitory storage medium according to claim 15, wherein presetting the series of unlocking numerals comprises recording any touch signal on the obverse touch panel using a first preset value, and recording any touch signal on the reverse touch panel using a second preset value.

17. The non-transitory storage medium according to claim 14, wherein determining a plurality of corresponding touch numerals comprises recording any touch signal on the obverse touch panel using a first preset value, and recording any touch signal on the reverse touch panel using a second preset value.

18. The non-transitory storage medium according to claim 17, wherein the method further comprises:
determining whether the touch numerals are equal to the preset unlocking numerals.

19. The non-transitory storage medium according to claim 18, wherein the method further comprises:
recording a quantity of digits present in the touch numerals, by adding one to a running total of the quantity of digits present each time a touch signal is received on the obverse touch panel and each time a touch signal is received on the reverse touch panel, wherein determining whether the touch numerals are equal to the preset unlocking numerals comprises determining whether the quantity of digits present in the touch numerals is equal to a quantity of digits present in the preset unlocking numerals.

20. The non-transitory storage medium according to claim 17, wherein the first preset value is one, and the second preset value is two.
